(19) United States
(12) Patent Application Publication
(10) Pub. No.: US 2014/0129318 A1
(43) Pub. Date: May 8, 2014

(54) INFLUENCING PRODUCT DEMAND BY AMPLIFYING DEMAND SIGNAL

(71) Applicant: MICROSOFT CORPORATION, Redmond, WA (US)

(72) Inventor: Ashvin Mathew, Sammamish, WA (US)

(73) Assignee: Microsoft Corporation, Redmond, WA (US)

(21) Appl. No.: 13/671,169

(22) Filed: Nov. 7, 2012

(51) Int. Cl. G06Q 30/02

(52) U.S. Cl. CPC G06Q 30/0242
USPC 705/14.41

(57) ABSTRACT

An application is enabled to influence product demand by amplifying demand signal. Product and customer information is analyzed for patterns within external resources. The patterns are combined to produce demand signal. The demand signal is matched to a target audience to amplify the demand. The product is presented to an audience to influence demand for the product through customer channels including advertising, pricing policies, and offers.

### BACKGROUND

Online purchase methods have greatly improved purchase options for modern customers. Following the expansion of the Internet, online product offerings and purchase systems expanded and improved exponentially over the last two decades. Text based product web pages evolved to multimedia content offering interactivity to potential purchasers. Modern purchasers can view visual presentation of a product containing extensive information about the product. Modern purchasers are enabled to research the product from variety of information resources including manufacturing sites to come up with a purchase decision. In addition, modern sales systems provide product use experiences through a customer's Internet enabled device. Furthermore, customers are sent promotions that are tailored to work on variety of platforms including mobile and desktop environments.

Product marketing can benefit from extensive analysis of customer and product information. Product and customer information based analysis is an area still in need of development. An analysis system can gather information from variety of resources hosting content about customer and product. Vast data warehouses collect and gather information about the customer and product. However, in modern systems, a product is seldom analyzed for customer demand. Absent such analysis, customer targeting is rarely utilized by current solutions. Targeting customers can affect the market for the product. Product flow and sales are seldom maximized in systems lacking targeted marketing.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to influencing product demand by amplifying a demand signal. According to some embodiments, a purchase management application may detect a demand signal from a recognized pattern within a resource. Demand signal may include product analysis information from a product market. Resources associated with the product and customer may be queried to recognize patterns about the product. In addition, the demand signal may be amplified by matching the product to an audience. Furthermore, advertising may be created for the audience matching the demand signal. The product may be presented to the audience to influence demand for the product.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 illustrates an example network diagram where an application may influence product demand by amplifying demand signal according to some embodiments;

FIG. 2 illustrates an entity diagram for determining patterns for a demand signal according to embodiments;

FIG. 3 illustrates demand signal amplification by creating an audience according to embodiments;

FIG. 4 illustrates another component diagram evaluating resources for product demand according to embodiments;

FIG. 5 is a networked environment, where a system according to embodiments may be implemented;

FIG. 6 is a block diagram of an example computing operating environment, where embodiments may be implemented; and

FIG. 7 illustrates a logic flow diagrams for a process influencing product demand by amplifying a demand signal according to embodiments.

### DETAILED DESCRIPTION

As briefly described above, product demand may be influenced by amplifying a demand signal. A demand signal may be gathered from recognized patterns about a product provided by the resources. Demand signal may be amplified by matching the product to an audience and presenting the product to the audience.

In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present disclosure is defined by the appended claims and their equivalents.

While the embodiments will be described in the general context of program modules that execute in conjunction with an application program that runs on an operating system on a computing device, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can for example be implemented via one or more of a volatile computer memory, a non-volatile memory, a hard drive, a flash drive, a floppy disk, or a compact disk, and comparable media.

Throughout this specification, the term “platform” may be a combination of software and hardware components for influencing product demand by amplifying a demand signal. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

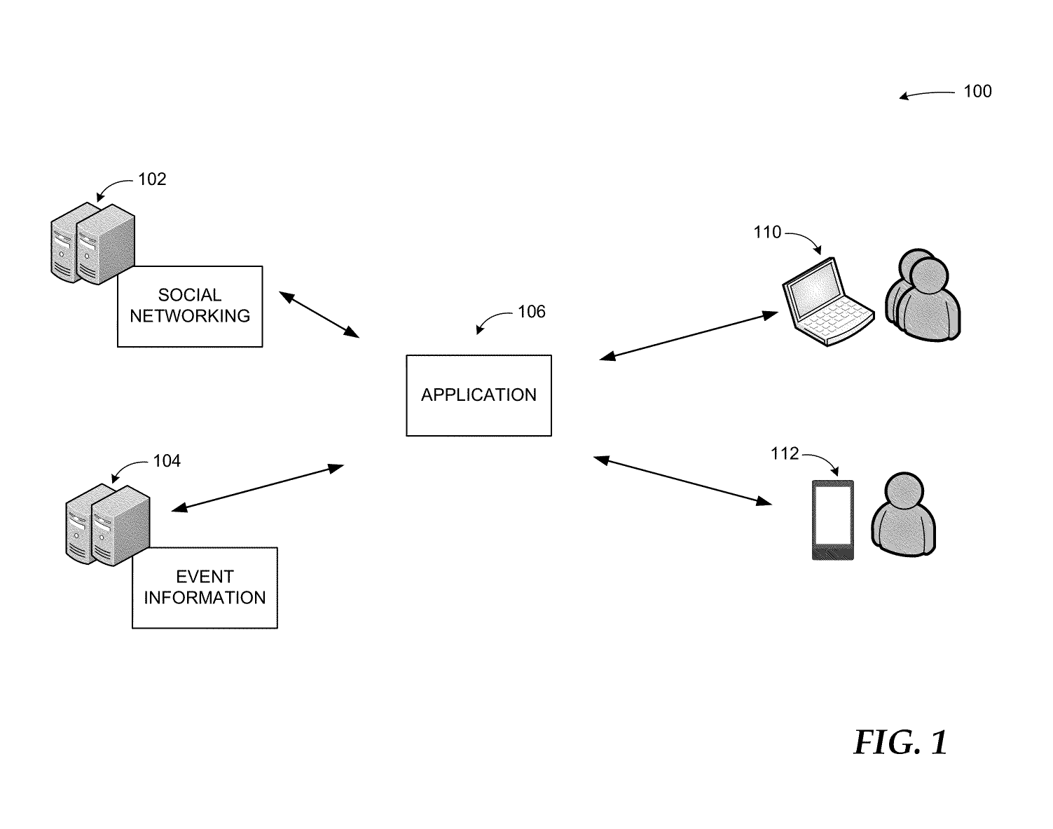

FIG. 1 illustrates an example network diagram where an application may influence product demand by amplifying demand signal according to some embodiments. The components and environments shown in diagram 100 are for illustration purposes. Embodiments may be implemented in various local, networked, cloud-based and similar computing environments employing a variety of computing devices and systems, hardware and software.

In an example environment illustrated in diagram 100, an application 106 may manage and analyze product demand. Analysis services may be provided for product and audience combinations. The application 106 may communicate with resource providers 102 and 104 to gather information about the product.

The server 102 may provide social networking services. Social networking server 102 may host vast relational information about an audience. The social networking server 102 may also contain marketing information about products of interest for the audience. In addition, server 104 may host event information. The event information server 104 may provide information about events which may alter product purchasing behavior of an audience. The application may gather and analyze customer and product information available from the servers 102 and 104 and match against an audience.

The audience may be determined through client devices including laptop 110 and smart phone 112. The client devices may host client applications that may accept information from the application 106 to influence demand from a product. There may be varying number of customers in an audience. In an example scenario, multiple customers may make up an audience with access to a laptop 110. In another example scenario, the application 106 may target individual customers through smart phone(s) 112.

In addition, the application 106 is not limited to client/server architecture. The application 106 may be executed wholly in a client device and query information resources directly without an intermediary for product demand analysis. Embodiments using other architecture models are also possible. For example, a distributed architecture may execute components of the application 106 in difference hardware to compartmentalize functionality.

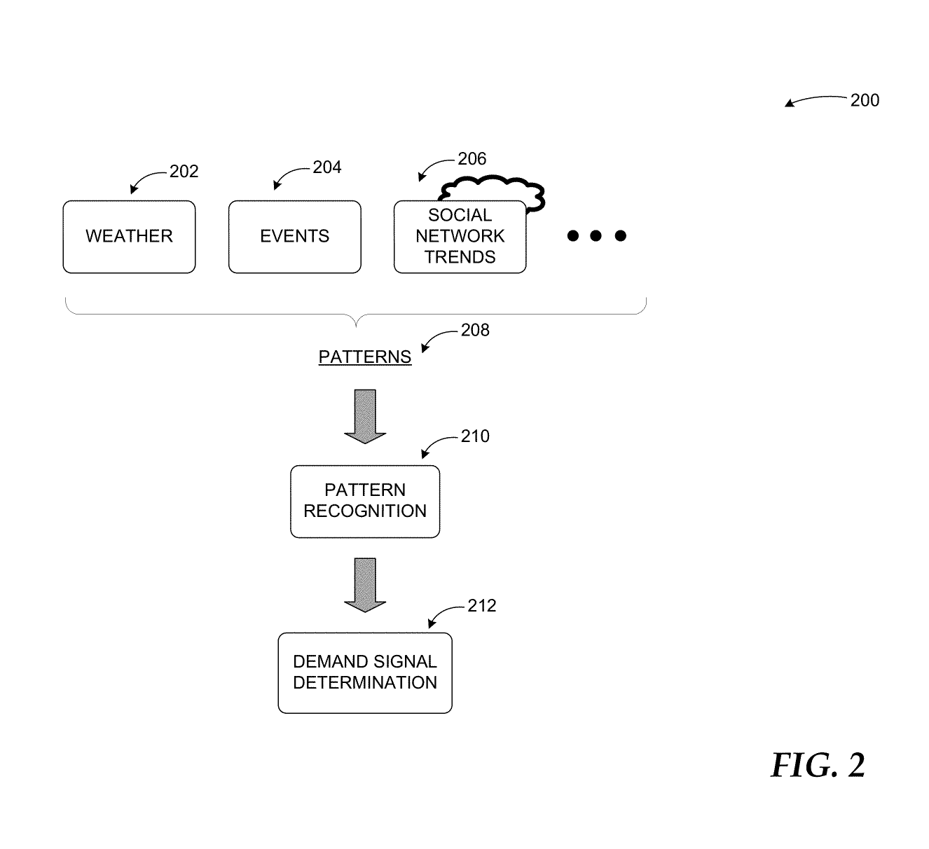

FIG. 2 illustrates an entity diagram for determining patterns for a demand signal according to embodiments. Diagram 200 displays example analysis of resources for product demand.

Resources accessible to an application may contain patterns 208 matching a product, according to embodiments. The patterns may include a variety of information matching the product. The information may include interest, disinterest, use trends, opinions, durability, features, lack of features, missing features, etc. In addition, the resources may not be traditional product sale environments but may include systems where a potential customer may provide information about the customer's habits. In an example scenario, weather provider 202 may contain information about a customer behavior that may alter the demand for a product. In an example scenario, the weather may predict rainy conditions which may provide patterns showing increase in sales of products providing protection from rain.

Events provider 204 may include patterns 208 about customer location and interest. Events may include variety of occasions in which products may be related to the event. An example may include a birthday event capturing information about customer's need to purchase products for the birthday. The event may also include and time and location information to further provide patterns about suitable products to target to a potential audience.

Social network trends 206 may provide additional patterns about customers and products. Social network trends may provide host of information including product reviews. Social network trends may also provide patterns about fashionable products, reliable products, unreliable products, product abundance, product scarcity, etc.

Product consumption patterns may also be analyzed from information provided by social network trends. Consumption patterns may be determined and assigned to a demand signal. The demand signal may be evaluated to optimize product presentation. The optimized product presentation may be implemented to influence the product demand. In an example scenario, social network patterns informing of a low performing product in a sales region may provide patterns to increase product presentation in that sales region. In another example scenario, the resource content may provide product saturation patterns in a sales region. The application may assign the saturation patterns to the demand signal and evaluate the demand signal to optimize market performance of the product. The product presentation in the sales region may be decreased accordingly.

Pattern recognition 210 may be handled by a module of the application. Patterns may be determined by using programmable rules. The application may provide default programmable rules. A customer or a system administrator may be allowed to alter the default rules and/or add new rules. An example default pattern recognition rule may include matching a product name to content from resources. The application may also provide rules matching audience types such as customer categories to recognize patterns from resource content.

Recognized patterns 208 may be analyzed to determine demand signals 212. Demand signals may encompass product consumption patterns. Demand signals may also include future product need. For example, patterns may be recognized about an upcoming product from social network resources. In addition, chatter from potential customers may be evaluated to predict product demand signal. Prediction of the product demand signal may include evaluating a monetary amount that the market may bear for the product. Demand signal may also include amount of product to be consumed by the market. The demand signal may produce region based analysis of product consumption.

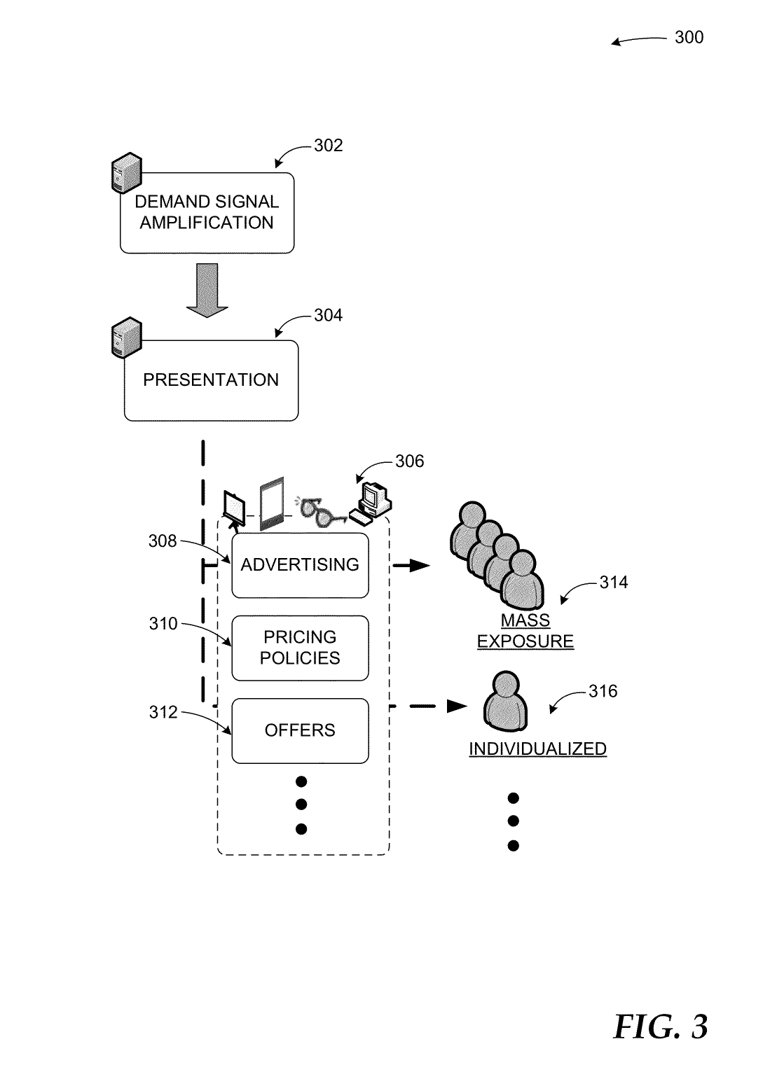

FIG. 3 illustrates demand signal amplification by creating an audience according to embodiments. Diagram 300 displays an example of demand signal amplification reaching the audiences.

An application according to embodiments may amplify signal demand 302 through analysis of information or content within resource associated with the product and presentation 304 of the product to audiences. Demand signal may be analyzed for a potential to improve product sales. For example, customized advertising 308 may be used to entice a potential customer to purchase the product. In addition, the advertising 308 may be customized with information from the demand signal relevant to the customer. The advertising may entice an individualized 316 audience with how a product may improve the individual's life. Alternatively, the application may generate advertising 308 for mass exposure 314 according to the demand signal. The application may analyze customers for common patterns and generate advertising according to the common patterns retrieved from the demand signal.

The presentation may be configured to accommodate devices 306 informing an audience. The application may configure advertising 308, pricing policies 310, and offers 312 for optimized viewing according to the devices 306 capabilities. The devices may include projector screens, smart phones, augmented reality capable devices, personal computers, etc. The presentation may be configured to match physical capabilities of the devices to maximize presentation effectiveness. An example may include sending a pop-up advertising to a smart phone to notify a user of a product within proximity of the user.

Pricing policies 310 may also be configured and adjusted to amplify the demand signal. The application may analyze the demand signal for optimum price, sale, and profit nexus. The price of the product may be altered to match the optimum nexus. In addition, the application may generate and submit offers 312 to amplify the demand signal. The offers may be generated to complement the demand signal. In an example scenario, the application may submit an offer to a potential audience to entice the audience to purchase the product and eliminate high initial payment apprehension. Offers may include discounts, coupons, future purchase discounts, memberships, payment plans, loan offers, etc.

Demand may be influenced by amplifying the demand signal and presenting the product through customer channels to matching audiences. The channels may include advertising, pricing policies, and offers as described previously. Audiences may be determined according to pattern analysis of product and customers from content provided by resources. In addition, the patterns with common elements may be combined into a demand signal about the product. The audience may be created from the at least one customer captured by the demand signal. In an example scenario, if a sporting event is taking place in a city, offers and pricing policies, and advertising may be adjusted for products and/or services affected by sporting event. Advertising may be sent to an audience configured for mass exposure by matching patterns recognized from the event to other customers. The advertising may also be customized for individual exposure by matching the patterns recognized from the event to a customer.

In another example scenario, pricing policies, offers, and advertising for a product may be determined according to patterns recognized from weather information. The pricing policies, offers, and advertising may be presented to an audience to entice the audience for purchasing the product. An example may include presenting winter products for upcoming severe winter weather to the audience. In addition, customers making up an audience may be reached through online sites, in-store displays, mobile applications, etc.

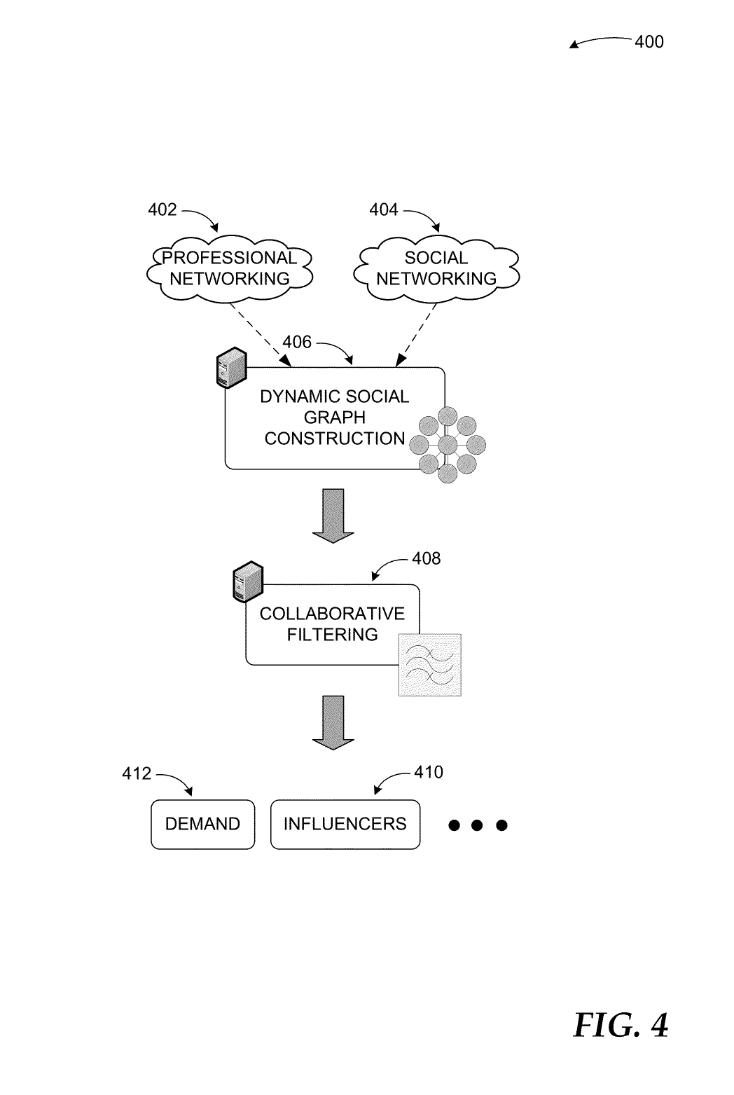

FIG. 4 illustrates another component diagram evaluating resources for product demand according to embodiments. Diagram 400 shows resource analysis to determine demand signals.

The application may analyze professional networking 402 and social networking 404 resources for patterns about the product. The professional networking resource 402 may provide business related information about customer and product patterns. Social networking resource 404 may provide general customer and product patterns. The application may analyze content from the resources in a dynamic social graph constructor component. The graph component 406 may relate product and customer patterns. The graph component 406 may group patterns with common elements into a demand signal. The graph component 406 may generate relational graphs predicting relationships between products and customers. The application may use the relationships as common elements to determine demand signal and target audiences.

Furthermore, analyzed patterns may be filtered through collaborative filtering component 408. The filtering component 408 may further determine relationships between products and potential audiences. The filtering component 408 may screen customers according to product interest patterns to determine an audience. In addition, demand component 412 may gather demand signal and amplify the demand signal using influencers 410. The influencers may include schemes to reach customers including advertising, pricing policies, and offers.

The example scenarios and schemas in FIG. 2 through 4 are shown with specific components, data types, and configurations. Embodiments are not limited to systems according to these example configurations. Above product examples are not given in a limiting sense. Other products and/or services may be used in place of given examples as provided above. In addition to products, services and combination of products and services may be analyzed by the embodiments to influence demand. Influencing product demand by amplifying demand signal may be implemented in configurations employing fewer or additional components in applications and user interfaces. Furthermore, the example schema and components shown in FIG. 2 through 4 and their subcomponents may be implemented in a similar manner with other values using the principles described herein.

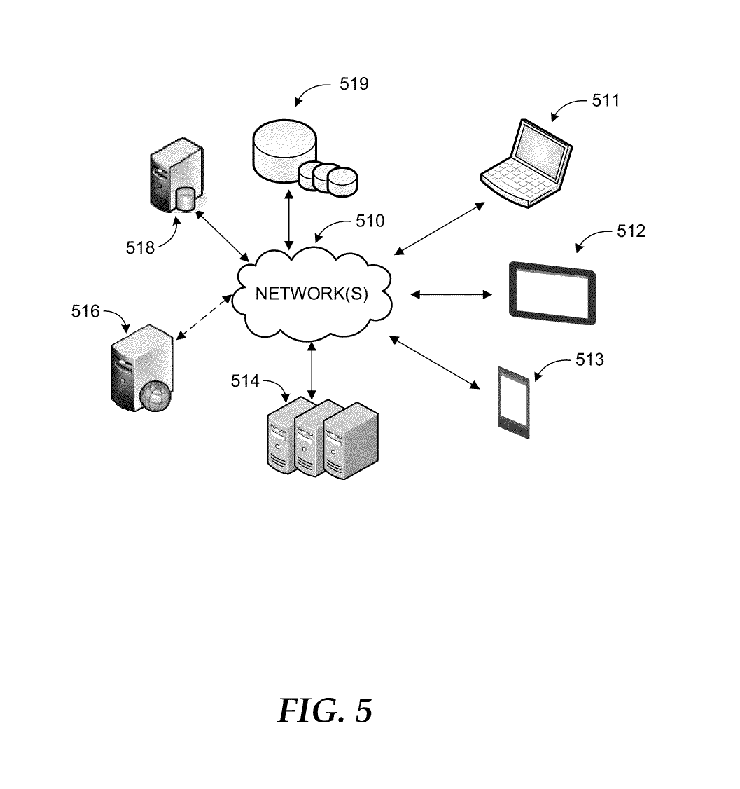

FIG. 5 is a networked environment, where a system according to embodiments may be implemented. Local and remote resources may be provided by one or more servers 514 or a single server (e.g. web server) 516 such as a hosted service. An application, such as a purchase management application, may execute on individual computing devices such as a smart phone 513, a tablet device 512, or a laptop computer 511 (‘client devices’) and communicate with customer and product information providers through network(s) 510.

As discussed above, an application may influence product demand by amplifying demand signal. Product and customer patterns may be determined from content provided by resources. The determined patterns may be coalesced into a demand signal. Demand signal may be amplified by customer channels to influence product demand. Client devices 511-513 may enable access to applications executed on remote server(s) (e.g. one of servers 514) as discussed previously. The server(s) may retrieve or store relevant data from/to data store(s) 519 directly or through database server 518.

Network(s) 510 may comprise any topology of servers, clients, Internet service providers, and communication media. A system according to embodiments may have a static or dynamic topology. Network(s) 510 may include secure networks such as an enterprise network, an unsecure network such as a wireless open network, or the Internet. Network(s) 510 may also coordinate communication over other networks such as Public Switched Telephone Network (PSTN) or cellular networks. Furthermore, network(s) 510 may include short range wireless networks such as Bluetooth or similar ones. Network(s) 510 provide communication between the nodes described herein. By way of example, and not limitation, network(s) 510 may include wireless media such as acoustic, RF, infrared and other wireless media.

Many other configurations of computing devices, applications, data sources, and data distribution systems may be employed to influence product demand by amplifying demand signal. Furthermore, the networked environments discussed in FIG. 5 are for illustration purposes only. Embodiments are not limited to the example applications, modules, or processes.

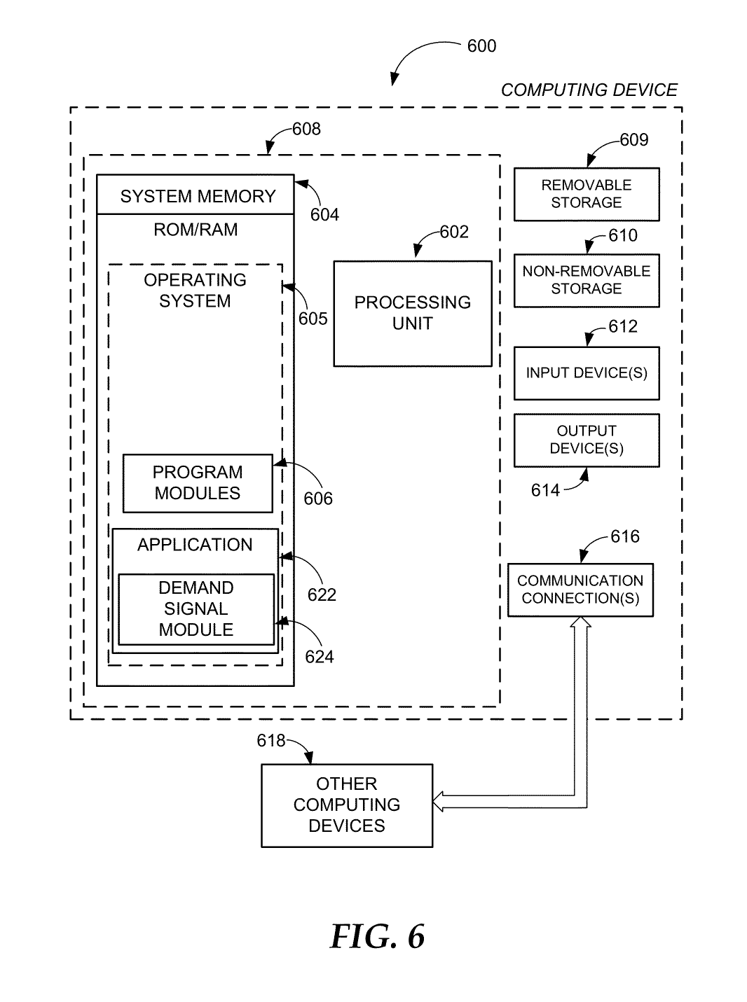

FIG. 6 and the associated discussion are intended to provide a brief, general description of a suitable computing environment in which embodiments may be implemented. With reference to FIG. 6, a block diagram of an example computing operating environment for an application according to embodiments is illustrated, such as computing device 600. In a basic configuration, computing device 600 may include at least one processing unit 602 and system memory 604. Computing device 600 may also include a plurality of processing units that cooperate in executing programs. Depending on the exact configuration and type of computing device, the system memory 604 may be volatile (such as RAM), non-volatile (such as ROM, flash memory, etc.) or some combination of the two. System memory 604 typically includes an operating system 605 suitable for controlling the operation of the platform, such as the WINDOWS® and WINDOWS PHONE® operating systems from MICROSOFT CORPORATION of Redmond, Wash. The system memory 604 may also include one or more software applications such as program modules 606, an application 622, and an demand signal module 624.

The application 622, such as a sales analysis application, may influence product demand by amplifying demand signal according to embodiments. The application 622 may analyze resource content for product and customer patterns. The demand signal module 624 may combine patterns according to relationship criteria between product and customer patterns. The demand signal module 624 may determine product demand signal from the combined patterns and amplify the signal utilizing customer channels. This basic configuration is illustrated in FIG. 6 by those components within dashed line 608.

Computing device 600 may have additional features or functionality. For example, the computing device 600 may also include additional data storage devices (removable and/or non-removable) such as, for example, magnetic disks, optical disks, or tape. Such additional storage is illustrated in FIG. 6 by removable storage 609 and non-removable storage 610. Computer readable storage media may include volatile and nonvolatile, removable and non-removable media implemented in any method or technology for storage of information, such as computer readable instructions, data structures, program modules, or other data. Computer readable storage media is a computer readable memory device. System memory 604, removable storage 609 and non-removable storage 610 are all examples of computer readable storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 600. Any such computer readable storage media may be part of computing device 600. Computing device 600 may also have input device(s) 612 such as keyboard, mouse, pen, voice input device, touch input device, gesture input device, and comparable input devices. Output device(s) 614 such as a display, speakers, printer, and other types of output devices may also be included. These devices are well known in the art and need not be discussed at length here.

Computing device 600 may also contain communication connections 616 that allow the device to communicate with other devices 618, such as over a wireless network in a distributed computing environment, a satellite link, a cellular link, and comparable mechanisms. Other devices 618 may include computer device(s) that execute communication applications, storage servers, and comparable devices. Communication connection(s) 616 is one example of communication media. Communication media can include therein computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be co-located with each other, but each can be only with a machine that performs a portion of the program.

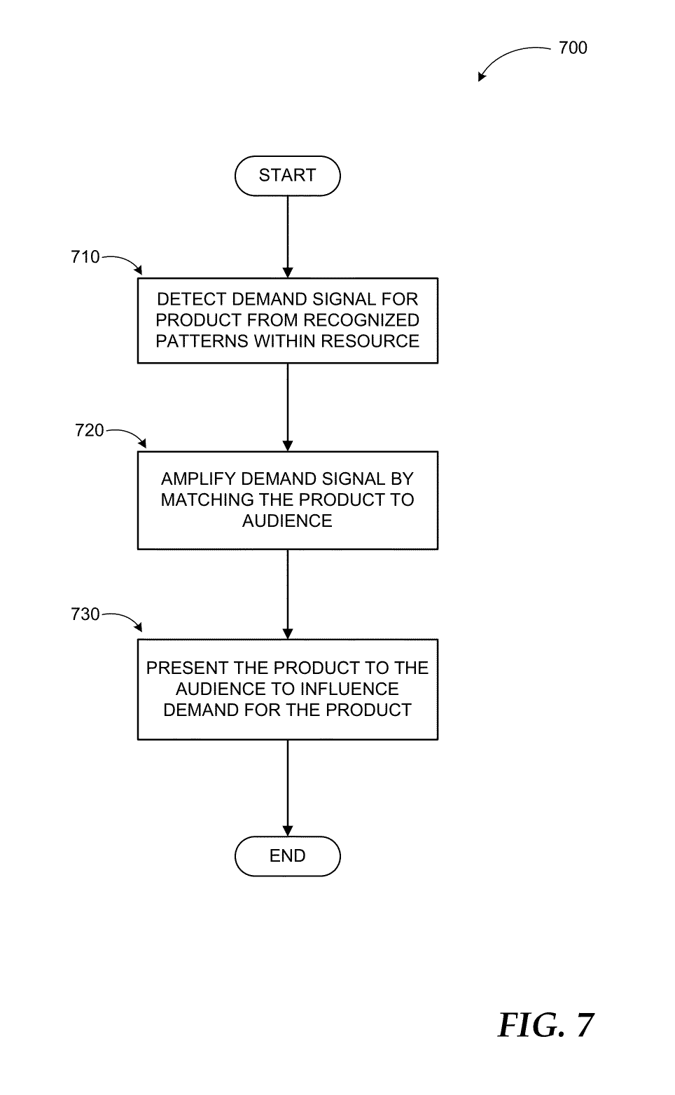

FIG. 7 illustrates a logic flow diagram for a process influencing product demand by amplifying a demand signal according to embodiments. Process 700 may be implemented by an application such as a sales analysis application in some examples.

Process 700 may begin with operation 710 where the application may detect a demand signal for a product from recognized patterns within a resource. Content provided by resources may be analyzed for patterns matching product and customer. The application may amplify demand signal by matching the product to an audience at operation 720. The audience may be determined from demand signal by analyzing relationships between customer and products. At operation 730, the application may present the product to the audience to influence demand for the product. Presentation of the product through customer channels may alter purchasing behavior of the audience to optimize product sales.

Some embodiments may be implemented in a computing device that includes a communication module, a memory, and a processor, where the processor executes a method as described above or comparable ones in conjunction with instructions stored in the memory. Other embodiments may be implemented as a computer readable storage medium with instructions stored thereon for executing a method as described above or similar ones.

The operations included in process 700 are for illustration purposes. Influencing product demand by amplifying demand signal according to embodiments may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method executed on a computing device for influencing product demand by amplifying a demand signal, the method comprising:
detecting the demand signal for a product based on recognized patterns from a plurality of resources;
amplifying the demand signal by matching the product to an audience; and
presenting the product to the audience to influence the product demand.

2. The method of claim 1, wherein the resources include at least one from a set of: a weather event, a social event, a professional networking resource, and a social networking resource.

3. The method of claim 2, further comprising:
analyzing content associated with the resources to determine the patterns matching on or more customers; and
evaluating the patterns to match interest from the one or more customers in order to predict the demand signal for the product.

4. The method of claim 2, further comprising:
analyzing the content associated with the resources to determine the patterns matching the product.

5. The method of claim 1, further comprising:
detecting the patterns that match at least one from a set of: a time value, a location, and an interest from an event resource.

6. The method of claim 1, further comprising:
detecting the patterns that match at least one from a set of: a fashionable product, a reliable product, an unreliable product, a product abundance value, and a product scarcity value from online discussion resources.

7. The method of claim 1, further comprising:
detecting the patterns that match a consumption value of the product;
assigning the consumption value to the demand signal; and
evaluating the demand signal for an optimized product presentation based on the consumption value to influence the product demand.

8. The method of claim 7, further comprising:
increasing the product presentation in a predefined sales region upon detecting a low performance value of the product in the sales region.

9. The method of claim 7, further comprising:
decreasing the product presentation in a predefined sales region upon detecting a saturation value of the product in the sales region.

10. The method of claim 1, further comprising:
using at least one programmable rule to determine one or more of the patterns; and
enabling at least one of: a customer and an administrator to alter the at least one programmable rule.

11. The method of claim 10, further comprising:
including at least one of: a rule matching a product name associated with the resources and another rule matching an audience type associated with the resources as the at least one programmable rule.

12. A computing device for influencing product demand by amplifying a demand signal, the computing device comprising:
a memory configured to store instructions; and
a processor coupled to the memory, the processor executing an application in conjunction with the instructions stored in the memory, wherein the application is configured to:
retrieve content associated with resources including at least one from a set of: a weather event, a social event, a professional networking resource, and a social networking resource;
analyze the content to determine patterns matching at least one of: one or more customers and a product;
detect the demand signal for the product from the patterns;
amplify the demand signal by matching the product to an audience including the one or more customers; and
present the product to the audience to influence the product demand through one or more audio and video presentation devices.

13. The computing device of claim 12, wherein the application is further configured to:
present the product to the audience through customer channels that include at least one from a set of: an advertising, a pricing policy, and an offer.

14. The computing device of claim 12, wherein the application is further configured to:
analyze the demand signal to determine one or more of: an optimum price, an optimum sale value, and an optimum profit value; and
alter a price of the product based on the analysis.

15. The computing device of claim 12, wherein the application is further configured to:
present one or more of: a discount, a coupon, a future purchase discount, a membership, a payment plan, and a loan offer to the audience complementing the demand signal in order to entice the audience to purchase the product and to eliminate a payment apprehension.

16. The computing device of claim 12, wherein the application is further configured to:
determine the audience by analyzing the demand signal.

17. A computer-readable memory device with instructions stored thereon for influencing product demand by amplifying a demand signal, the instructions comprising:
retrieving content associated with resources including at least one from a set of: a weather event, a social event, a professional networking resource, and a social networking resource;
analyzing the content to determine patterns matching at least one of: one or more customers and a product;
detecting the demand signal for the product from the patterns;
analyzing the demand signal to determine a nexus including at least one from a set of:
an optimum price, an optimum sale value, and an optimum profit value;
amplifying the demand signal by:
matching the product to an audience including the one or more customers; and
altering a price of the product to match the nexus; and
presenting the product to the audience to influence the product demand through customer channels that include one or more of: an advertising, a pricing policy, and an offer.

18. The computer-readable memory device of claim 17, wherein the instructions further comprise:
customizing the audience for mass exposure by matching the patterns recognized from a social event to a variety of categories of customers.

19. The computer-readable memory device of claim 17, wherein the instructions further comprise:
customizing the audience for individual exposure by matching the patterns recognized from a social event to at least one customer.

20. The computer-readable memory device of claim 17, wherein the instructions further comprise:
determining one or more of: an advertising, a pricing policy, and an offer for the product based on the patterns recognized from at least one of weather information and a social event information.
